(19) United States
(12) Patent Application Publication
(10) Pub. No.: US 2026/0030507 A1
(43) Pub. Date: Jan. 29, 2026

(54) Distributed Design for Deep Reinforcement Learning and Scalable Service Function Chain Provisioning with Efficient Path Discovery

(71) Applicant: Ciena Corporation, Hanover, MD (US)

(72) Inventors: Murat Arda Onsu, Ottawa (CA); Poonam, Ottawa (CA); Burak Kantarci, Ottawa (CA); Emil Janulewicz, Ottawa (CA)

(73) Assignee: Ciena Corporation, Hanover, MD (US)

(21) Appl. No.: 18/781,238

(22) Filed: Jul. 23, 2024

(51) Int. Cl. G06N 3/092

(52) U.S. Cl. CPC G06N 3/092

(57) ABSTRACT

A system for networking and computing is provided herein which can include one or more processors and a memory storing instructions that cause the system to receive a request for a SFC in a network having a plurality of data centers arranged in clusters, wherein the SFC includes one or more VNFs located in the data centers in which packets traverse for various services, provide details of the request to one or more local agents each covering a cluster, and is configured to determine provisioning aspects of the SFC in the corresponding cluster, and receive the provisioning aspects for the SFC from the one or more local agents.

### FIELD OF THE DISCLOSURE

The present disclosure relates generally to networking and computing. More specifically, the present disclosure relates to systems and methods for distributed approaches for service function chaining provisioning based on deep learning and/or reinforcement learning.

### BACKGROUND OF THE DISCLOSURE

Conventional networking architecture can depend on a variety of specialized hardware. Such hardware conventionally provides high quality, stability, and strict protocol adherence to the associated networks. As a result, lengthy product cycles, low service agility, and an increased reliance on hardware have begun to burden the networking architecture. One approach to limiting these burdens is the introduction of High-quality Service Function Chaining (SFC) provisioning. SFCs typically rely on the execution of Virtual Network Functions (VNF) in a predefined sequence. To encourage the incorporation of SFCs, machine learning techniques, notably deep learning, and reinforcement learning (RL) have been integrated. Unfortunately, in expansive networks that encounter large demands, these centralized solutions face significant challenges. The magnitude of requests in combination with stringent End-to-End (E2E) delay requirements poses challenges for centralized systems, which can impede their ability to effectively manage and optimize service delivery.

### BRIEF SUMMARY OF THE DISCLOSURE

Disclosed is a distributed method for service function chaining (SFC) provisioning which can be based on deep reinforced learning (DRL). The method can comprise partitioning the network into smaller clusters, each of which can be managed by local agents. The local agents can be responsible for a variety of administrative tasks, such as handling SFC requests within their assigned cluster. The method can include a general agent which can be configured to oversee the entire network. In some aspects, the local agents in separate clusters can utilize an advanced DRL architecture to handle multiple inputs which can allow them to achieve improved performance. Again, the present disclosure can provide systems and methods for dividing networking tasks and assigning the divided tasks to a plurality of local agents which can be overseen by a general agent.

In one aspect, disclosed is a system, the system including one or more processors, and memory storing instructions that, when executed, cause the one or more processors to receive a request for a SFC in a network that includes a plurality of data centers arranged in a plurality of clusters, wherein the SFC includes a plurality of VNFs located in one or more data centers in which packets traverse for various services being applied thereon, provide details of the request to one or more local agents of a plurality of local agents, wherein each local agent covers a cluster of the plurality of clusters, and wherein each local agent is configured to determine provisioning aspects of the SFC in the corresponding cluster, and receive the provisioning aspects for the SFC from the one or more local agents.

In a further aspect, disclosed is a method which can include the steps of receiving a request for a SFC in a network that includes a plurality of data centers arranged in a plurality of clusters, wherein the SFC includes a plurality of VNFs located in one or more data centers in which packets traverse for various services being applied thereon, providing details of the request to one or more local agents of a plurality of local agents, wherein each local agent covers a cluster of the plurality of clusters, and wherein each local agent is configured to determine provisioning aspects of the SFC in the corresponding cluster, and receiving the provisioning aspects for the SFC from the one or more local agents.

In a yet further aspect, disclosed is non-transitory computer-readable medium defining instructions that, when executed, cause one or more processors to implement steps of receiving a request for a SFC in a network that includes a plurality of data centers arranged in a plurality of clusters, wherein the SFC includes a plurality of VNFs located in one or more data centers in which packets traverse for various services being applied thereon, providing details of the request to one or more local agents of a plurality of local agents, wherein each local agent covers a cluster of the plurality of clusters, and wherein each local agent is configured to determine provisioning aspects of the SFC in the corresponding cluster, and receiving the provisioning aspects for the SFC from the one or more local agents.

### BRIEF DESCRIPTION OF THE DRAWINGS

The present disclosure is detailed through various drawings, where like components or steps are indicated by identical reference numbers for clarity and consistency.

FIG. 1 is a diagram of a system model featuring diverse clusters of VNFI-enabled Data Centers in accordance with one aspect of the present disclosure.

FIG. 2 is a diagram of an advanced DRL model architecture with multiple inputs in accordance with another aspect of the present disclosure.

FIGS. 3A-3B are a diagram of a DRL model and SFC provisioning algorithm workflow in accordance with an alternative aspect of the present disclosure.

FIG. 4 is a graph of the SFC acceptance ratio in type-wise comparison to baseline centralized approach and distributed design under 40 DC and acceptance ratio under different clusters and DC numbers for distributed designs.

FIG. 5 is a graph of the SFC acceptance ratio and E2E delay under different DCs.

FIG. 6 is a graph of the SFC acceptance ratio and E2E delay under different cluster sizes for local agents.

FIG. 7 is a flow diagram of a process for SFC provisioning based on DRL utilizing local agents in one or more clusters in accordance with yet another aspect of the present disclosure.

FIG. 8 is an alternative aspect of a block diagram of a server in accordance with yet another aspect of the present disclosure.

### DETAILED DESCRIPTION OF THE DISCLOSURE

Again, the present disclosure relates generally to service function chaining (SFC) provisioning in networking and computing. More specifically, the present disclosure relates to systems and methods for advanced deep reinforced learning (DRL) model architecture which can include one or more input layers for difference features which can be independent of clusters' configuration changes. Some aspects of the disclosed DRL models can be used in a variety of network configurations. Moreover, some aspects of the DRL models of the present disclosure can be applied to various data centers (DC) and virtual network functions (VNF) which can lead to increased efficiency.

Additionally, the present disclosure relates to scalable distributed design which can be configured to engage high volume SFC requests in large-scale networks. The present disclosure relates to trained DRL architecture defining three input states in an initial layer which can be configured to receive various types of environmental data. Such a DRL architecture can be utilized under various network configurations without any substantial modifications which can allow local agents to operate with the same DRL model architecture regardless of the network configurations of their clusters. Further, the present disclosure includes a system of priority scores which can be assigned to DCs which can consider their resource availability in view of SFC demands.

### Network Architecture

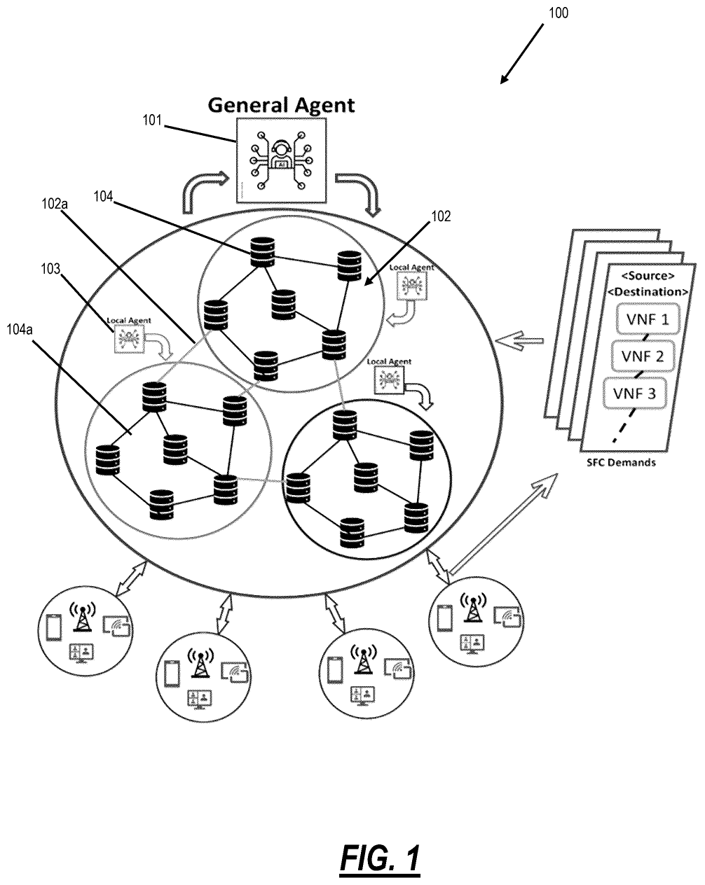

Turning now to FIG. 1, a diagram of a network 100 featuring diverse clusters of VNF Infrastructure (VNFI)-enabled Data Centers is shown and described. In some aspects, the network 100 can include a general agent 101. In some aspects, the general agent 101 can be software, an application, or a hardware component that is configured to perform specific set of predefined functions and/or tasks on behalf of another entity within the network. In some aspects, the general agent 101 can be configured to serve as an agent within the network 100. In some aspects, the general agent can be configured to operate adjunct to the network 100. More generally, the general agent 101 can be configured to operate outside of the system model. For example only, and without limitation, the general agent 101 can be configured to collect data about network parameters, such as network performance, health, configurations, and status, and can optionally report this information to other partitions of the network 100 or network. Again, the general agent 101 can be configured to oversee the entirety of the network 100. In some aspects, the general agent 101 can be the global agent. In some aspects, the general agent 101 can include the overall network information, for example DCs and associated connections.

In some aspects, the network 100 can define one or more clusters 102. The cluster can be a group of interconnected processors or computers which can be configured to work together as a single system. For example, the cluster 102 can include a plurality of communicatively coupled computers to improve one or more of performance, provide redundancy, and enhance availability. In some aspects, the network 100 can include a plurality of clusters 102, wherein each cluster 102 of the plurality of clusters 102 can be in common communication. For example only, each of the clusters 102 of the plurality of clusters 102 can be communicatively coupled via a cluster connection 102a. The cluster connection 102a can be configured to interconnect each of the clusters 102. In various aspects, the clusters 102 can include one or more DCs 104. The DCs 104 can be any device, hardware, or software which can provide data. In some aspects, the DCs 104 can be one or more networked computer servers and optionally related equipment. For example only, the DCs 104 can be configured to act as functional servers, process data, run applications, store data, function as switches, routers, firewalls, load balancers, or the like. In some aspects, each of the clusters 102 can include a plurality of DCs 104, wherein each of the DCs 104 of the plurality of DCs 104 can include a local connection 104a wherein the local connection 104a is configured to communicatively coupled each of the plurality of DCs 104.

In some aspects, the network 100 can include a plurality of clusters 102 each include a plurality of DCs 104. In an operational example, the general agent 101 can be configured to divide the network 100 into a predefined number of clusters 102. The clusters 102 can be grouped based on, for example and without limitation, function, service, instruction, protocol, or any function-based grouping. In some aspects, the general agent 101 can be configured to divide and/or group the clusters 102 as a first action after initialization. In some aspects, the general agent 101 can be configured to divide the clusters 102 based on considering the location of the DCs 104 on the network. The general agent 101, and more generally the network 100 can incorporate an algorithm or numerical method which can restrict cluster size to a predefined number. For example, the general agent 101 can incorporate a constrained K-Means algorithm, wherein the network 100 can be divided in different clusters 102 using the K-Means algorithm with a limit on the maximum number of clusters and/or DCs 104 in each cluster 102. In various aspects, after the clusters 102 and/or DCs 104 are divided, the general agent can be configured to assign a local agent 103.

In various aspects, the network 100 can include one or more of the local agents 103. The local agents 103 can be within the network 100 and communicatively coupled therewith. For example, the network 100 can include a plurality of the local agents 103 which can be assigned to the plurality of clusters 102. More particularly, each of the clusters 102 can include one of the local agents 103. In some aspects, the general agent 101 can assign the local agents 103 and/or oversee the local agents 103. Moreover, the general agent 101 can be configured to facilitate communication among the local agents 103. In some aspects, the local agents 103 can be communicatively coupled via the general agent 101. The general agent 101 can be configured to manipulate at least one of the local agents 103. For example, the general agent 101 can be configured to intervene in a situation where the local agent 103 or assigned cluster 102 or DC 104 may require further resources for VNF placements. In a further example, the general agent 101 can be configured to intervene when the destination of a SFC request lies outside the scope or jurisdiction of the local agent's 103 assigned cluster 104. In some aspects, the local agents 103 can be configured to determine provisioning aspects of the SFC, for example in the corresponding cluster and provide the provisioning aspects for configuring.

In various aspects, each local agent 103 can be responsible for its assigned cluster 102. In other aspects, each local agent 103 can be solely responsible for its assigned cluster 102 and responsibility outside of the local cluster 102 can be restricted. More specifically, each local agent 103 can be configured to consider at least the DCs 104 and logical links therebetween. In an example embodiment, each local agent is only responsible for its assigned cluster 102, and more specifically, it's assigned cluster's 102 DC 104 and logical links. In some aspects, the local agent 103 is separated from communicating with the DCs 104 of other clusters 102 or logical links communicatively coupled to other clusters 102 DCs 104. Again, in example embodiments, each local agent 103 can be independent of the other local agents 103 and can not directly communicate therebetween outside of common communication with the general agent 101. Each local agent 103 can be configured to act as an agent for their assigned cluster 102. For example, the local agents 103 can perform tasks with respect to their assigned cluster 102, such as SFC provisioning tasks. In some aspects, the local agents 103 can include a DRL model and associated algorithms. In some embodiments, each of the plurality of local agents 103 can include the same DRL model and associated algorithms. Moreover, in an alternative aspect, once SFC demands are created, each local agent 103 of the plurality of local agents 103 can focus on the demands generated for its assigned cluster 102 and/or DC 104 as the demand source address and handles the SFC provisioning tasks via proper VNF placement to its DCs 104. Further, the local agent 103 can be adapted to communicates with the general agent 101 if the SFC provision task requires information or resources beyond the local agent's scope i.e., when tasks exceed a local agent's 103 capabilities and need connections between DCs 104 across different clusters 102.

In some aspects, the network 100 or any portion thereof can be configured for packet transmission. More generally, the network 100 or any portion thereof can be configured to transmit or receive data, such as in the form of packets, from one device or network to another device or network. As used herein, the term “packet” can refer to a small unit of data formatted for transmission. In some aspects, the network 100 or any portion thereof can be configured for packet switching. More generally, the network 100 or any portion thereof can be configured for switching or grouping data into packets which can then be transmitted over a network. In many aspects, the network 100 can be configured for packet transmission via an optimum path, wherein the optimum path can be the shortest path in consideration of the available bandwidth. The network 100 or any portion thereof can be configured to select from one or more paths of transmission the shortest path for data transmission. In various aspects, the network 100 can be configured to utilize a path discovery algorithm, wherein each DC 104 can be considered a node and each connection (e.g., the cluster connection 102a and/or the local connection 104a) can be considered a bidirectional link. Continuing in example, the network 100 can determine the shortest path from all available paths and can then retain the shortest path. Such a method can be called “DC-to-DC” path discovery.

In another aspect, disclosed is a method for data transmission. More specifically, disclosed is a method for “cluster-to-cluster” path discovery. In some methods, the network 100 can be configured to determine if the transmission source and transmission destination reside in the same nexus, for example, within the same cluster 102. Some methods can include applying the “DC-to-DC” path discovery method and any relevant packet transmission. For example, the method can include determining the location and destination of the packet transmission and then optionally applying “DC-to-DC” methods of packet transmission. In some methods, if the destination is outside of the scope of the local agent 103 and/or if there is no available cluster connection 102a for the destination, the “cluster-to-cluster” method can be applied. One aspect of the “cluster-to-cluster” method can include determining the shortest available path from source to destination. Moreover, some aspects of the “cluster-to-cluster” method can include the local agent 103, wherein the local agent 103 can be configured to selectively communicate with the general agent 101. In some methods, the “cluster-to-cluster” method can include the general agent 101 drawing or defining a path from the source DC's 104 cluster 102 to the destination DC's 104 cluster 102. The method can include utilizing a Depth First Search (DFS) algorithm. More generally, the method can include utilizing an algorithm or function configured for traversing or searching a data structure. The method can include iterative traversal from cluster 102 to cluster 102 using “DC-to-DC” path discovery inside each cluster 102 until reaching the destination. Moreover, the method can include systematically exploring one or more nodes or devices in a network without using recursion. In some aspects, the method can include utilizing recursive traversal, wherein the process calls itself at least once. It is envisioned that, in some embodiments, such iterative transversal can provide reduced inference time for path discovery to an either defined or undefined feasible value.

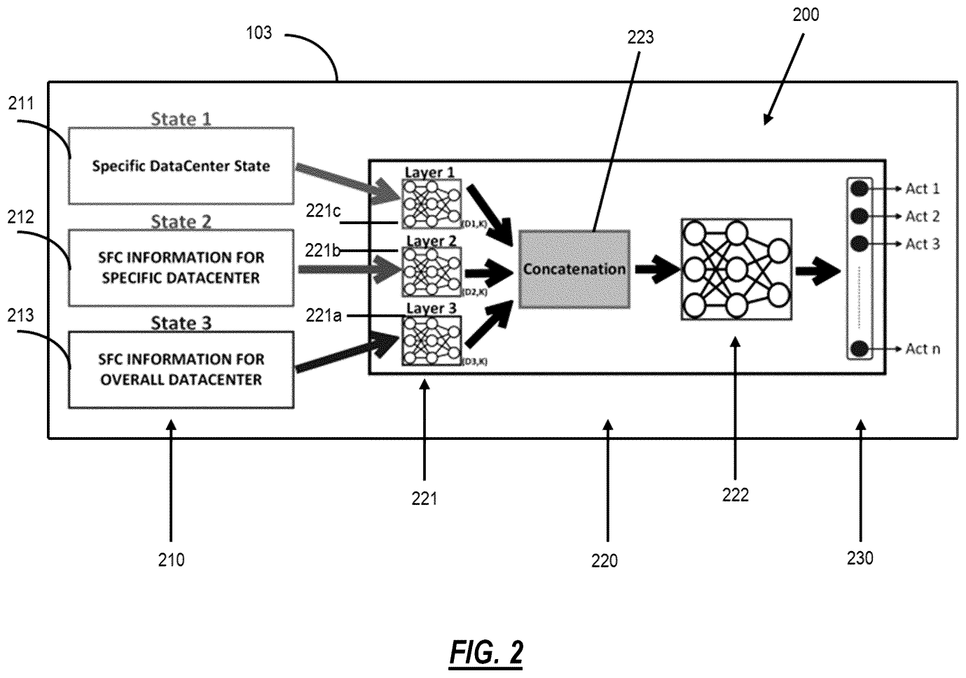

In some embodiments, the local agents 102 can be configured to operate or function independently from each other. It is envisioned that such independent operation can allow for variations or variability in the number or locus of DCs 104 and/or cluster or local connections 102a, 104a within the network 100. In some aspects, the distributed approach as provided herein can require that each of the one or more local agents 103 demonstrate adherence to the same model architecture. More specifically, each local agent 103 can demonstrate common structured design and network framework, such as for example and without limitation, devices, protocols, services, or the like. In some aspects, the local agents 103 input and output states can be contingent on environmental factors and the scope of actions. For example, an increase in the number of DCs 104 can result in large input sizes and action spaces. Resultingly, the network 100 can be configured to incorporate or include a DRL model, such as an advanced DRL model architecture which can include a multiplicity of input layers. Such DRL architecture can be leveraged as an enabler which can take information from the network environment (shown in FIG. 2). In example, the Model's output can indicate the type of action to be performed which can be placing VNF, Uninstalling VNFs or Idle Wait. If the action is VNF placement, the most proper VNF function must be selected for placing. In this case, priority points are used to prioritize each VNF considering their E2E latency, SFC's last processed function's location, and source and destination DCs. Then, based on the highest priority points VNF type is selected to be installed.

In further discussion, the general agent 101 can be a higher priority agent when compared to the local agents 103. In an aspect of operation, once the system is initialized, the general agent 101 is generated first and can be given overall network information, such as information pertaining to DCs 104 and connections therewith. The general agent's 101 first action after initialization can be to divide the network 100 into a predefined number of clusters 102 which can be done in consideration of the DC's 104 location relative to the network 100. Further, the general agent 101 can be configured to prevent one or more clusters 102 from receiving more DC's 104 than predicted, which can be accomplished algorithmically, such as for example with the constrained K-Means algorithm. Such algorithmic methods can be utilized to restrict cluster size to a pre-defined limit. The general agent 101 can be configured to create one or more of the local agents 103. In some aspects, after local agent 103 creation, the general agent 101 can assign one of the local agents 103 to one of the clusters 102. In some aspects, the global agent 101 can be configured to distribute its global model among each of the local agents 103. The global model can be configured for SFC provisioning tasks. Again, each of the plurality of clusters 102 can be assigned one of the plurality of local agents 103.

The general agent 101 can be configured to observe and monitor the network 100 and, more specifically, one or more of the local agents 103. The general agent 101 can be configured to assist the local agents 103 with tasks, for example packet transmission if the packet transmission is beyond the scope of the local agent 103. The general agent can be configured for performance analysis of each of the local agents 103. The general agent 101 can be configured to hold information related to the number of SFCs each local agent 103 satisfies or drops. In other aspects, for distributed learning, the general agent 101 can be configured to receive a trajectory data of all of the local agents 103 and can initiate a learning phase. The learning phase can include updating the global model weights, which can be shared with the local agents 103.

Each of the plurality of the local agents 103 can be created by the general agent 101. It is envisioned that such creation can be only after the environmental clustering. The general agent 101 or any portion of the network 100 can assign one of the local agents 103 to one of the clusters 102, wherein each cluster 102 of the plurality of clusters 102 can be assigned a dedicated local agent 103. Clusters 102 can include DCs 104, connections such as cluster and local 102a, 104a, and SFC demands come to these DCs 104. The local agents 103 scope can be only its interior DC 104 and connections, and they can lack any knowledge about connections between neighbor clusters 102 or the environment. In other words, each local cluster 102 can be independent of the others, and they can communicate with only the general agent 101.

As mentioned in previously, local agents 103 can be configured to perform the SFC provisioning task via DRL models and algorithms. Each local agent 102 can share a common DRL model architecture and algorithm, which is also can be shared by the general agent 101. Once SFC demands are created, the local agent 103 who holds the DC 104 with the demand source address handles the SFC provisioning tasks via proper VNF placement to its DCs. Communication with the general agent 101 can be made if the task requires information beyond the local agent's 103 scope. Communication between each of the local agents 103 and the general agent 101 can be primarily for a packet transmission phase. In example, if a packet needs to be transferred but local agents 103 cannot determine an available route inside their cluster, they can send the current DC 104 of the packet and destination address to the global model due to the global model's comprehensive information about the overall network. In some aspects, packet transfer can be made either during the VNFs processing phase or after processing is completed. During the VNF placement process, if VNFs in the same SFC are installed in different DCs 104, packet transmission can happen between these DCs 104. Local agents 103 can be configured to install VNFs in their assigned DCs 104 or clusters 102, regardless of the availability of in cluster connection 102a between DCs 104. In such example circumstances, the local agent 103 can request the general agent 101 to determine the available path. The general agent 101 can determine or draw the route using one or more varying cluster's 102 connections. In some aspects, the general agent 101 can determine or draw the route using neighboring clusters 102 cluster path connection 102a or cluster path.

In some aspects, once all VNFs in a SFC have been processed, the demand can be sent to the destination DCs 104. In some aspects, if the destination DCs 104 can be in a different cluster 102, the local agent 103 can not find a route even with available connections, or if there is no available path, the local agent 103 can be configured to communicate with the general agent 101. Under such circumstances, the general agent 101 is configured to find alternative routes, such as other cluster connections.

### Deep Reinforcement Learning Model

Turning now to FIG. 2, shown is diagram of an advanced DRL model 200 architecture with multiple inputs in accordance with another aspect of the present disclosure. In some aspects, the local agent 103 can include the DRL model 200 architecture. The DRL model 200 architecture can be any framework or design principals which are configured to learn or make decisions by interacting with an environment through trial and error. In some aspects, the DRL model 200 architecture can include a combination of RL and DL which can be configured to enable agents to learn from relatively high-dimensioned inputs, such as for example and without limitation, images or complex state representations. In many aspects, the local agent 103 and optionally the general agent can be configured to utilize the DRL model 200 architecture. In one embodiment, the DRL model 200 architecture or SFC provisioning algorithm can be divided into one or more parts. More specifically, the DRL model 200 architecture or SFC provisioning algorithm can be divided into three main components: state information 210, model processing 220, and action 230 performance. More specifically, the DRL model 200 architecture can be divided into environmental state information 210 collection and creation of DCs 104 iteration order, DRL model processing 220, and assigning priority points to VNFs and performing actions 230.

The DRL model 200 architecture can be configured to collect one or more types of state information 210. In some aspects, the DRL model 200 architecture can be configured to collect information related to SFC and DC 104 attributes. In various aspects, the DRL model 200 can be configured to create a DC 104 iteration order list which can be based on resource availably and optionally E2E delay of incoming SFC requests before collecting state information 210. Such a list of the previous aspect can be structured to prioritize DCs 104 with any of pending requests, those on the path of requests, and those with no requests. In some aspects, once the DC 104 iteration order is established, the DRL model 200′s state information 210 can be defined by the examination of current DC 104 attributes and overall SFC information. The examination may also involve referencing an overall list of VNFs and their associates SFCs to determine the status of SFC requests and remaining VNF functions.

In a further aspect, in the model processing 220 phase of the DRL model 200, the DRL model 200 can be configured to process the state information 210 and can be configured to generate outputs representing possible actions 230. These actions 230 can include, but are not limited to, placing, installing, uninstalling VNF function or waiting. The DRL model 200 can include an algorithm which can be adapted to verify the validity of the action 230. More specifically, the DRL model 200 can be configured to verify the validity of the action 230 through assertion phases. Priority metrics, such as priority points can be assigned to VNFs based on a variety of factors for example and without limitation, the remaining time before an SFC is dropped, the importance of VNFs which can be based on their latest processed functions DC 104, the deployment status of VNFs in the current DC 104, and the urgency of VNF functions. In some aspects, the DRL model 200 can be configured to select the VNF type based on the assigned priority metric. More specifically, the model processing 220 phase of the DRL model 200 can be configured to utilize an algorithm to select the VNF type based on the assigned priority points. In other aspects, for uninstallation algorithms, the model processing 220 phase of the DRL model 200 can be configured to select idle functions with maximum idle time. The model processing 220 phase of the DRL model 200 can be configured to update its current state and store relevant information for model training.

In many aspects, the DRL model 200 can be configured to eliminate the need for large-scale training and/or simultaneous training. The DRL model 200 can be configured to be deployed in different cluster 102 environments which can lead to significant time savings. In some embodiments, the DRL model 200 of the present disclosure can include clustering-based distributed designs which can assign each local agent 103 the task of managing a specific cluster 102 of data centers 104. Such an approach can result in each local agent 103 handling SFC requests within its cluster 102 and ameliorate request overloading. It is envisioned that local agents 103 are not restricted by resource availability. The local agent 103 can be configured to collaborate with the general agent 101 and/or deploy the same if the local agent's 103 resources are exhausts. The general agent 101 can be configured to deploy VNFs in available DCs 104 in other clusters 102 and begin packet transmissions to those DCs 104. Another aspect of the present disclosure relates to the packet transmissions which can include locating paths within the network. In other aspects, the DRL model 200 can be configured to discover the optimal shortest path. More specifically, when the source and destination are within the same cluster 102, the DRL model 200 can concentrate exclusively on in-cluster DCs 104 which can minimize the time required for pathfinding. In an example, if the source and destination reside in different clusters 102, the DRL model 200 can utilize cluster-to-cluster path discovery which can facilitate efficient navigation across large networks.

In some aspects, the state information 210 can include one or more individual state input layers. In various aspects, the state information 210 can define three inputs layers defining a first state 211, a second state 212, and a third state 213. The first and second input states 211, 212 can define information about the current DC 104 the algorithm chooses to perform an action. The third input state 213 can define overall system information for SFC demands. More specifically, the first state 211 can define the specific data center state, the second state 212 can define SFC information for the specific DC 104, and the third state can define SFC information for overall DCs 104. In the first state 211, information regarding the quantity of VNF functions that are installed, and/or the quantity of available functions that are available for allocation alongside available storage and computations power for selected DCs 104 can be provided. In the second state 212, the state if the incoming SFC requests for DCs 104 can be provided. In an alternative example, the second state 212 can be configured to show if the SFC demand is sent to a specified DC 104. The second state 212 can define a means to count groups by their types and processing stage of VNFs for these SFCs. It should be noted that there can be different VNF function, which can be presented as one or more values by the second state 212. The following is a non limiting example of the second state 212 operation:
The second state 212 can include SFC count groups by their types and processing stage of VNFs for these SFCs. There can be different VNF functions, and in the second state 212 each VNF function is presented in two values (Vta, Vtw). (Vta is the VNF function with type t which is already allocated and (Vtw is the VNF function type t waiting for the allocation. In the initial state, all these values start with 0. Whenever the DRL model 200 decides to place one function in the SFC states, states of this type of VNF turn to (1, 0) while other functions' states become (0, 1) until they are placed. These dynamic changes allow the model to learn the sequence of the VNF chain of the SFC.

The third stage 213 can be configured to define the overall SFC demand information of the network which can include information pertaining to the type, the count, VNF functions count, waiting of allocation, bandwidth, and remaining E2E latency for each type of SFC. It is envisioned that some or all of this information can be forwarded to the DRL model 200 through the input layer. It should be noted that all local agents 103 can share the same model architecture. As a result, at least one of the state information 210 dimensions are independent of network configurations, for example the quantity of DCs 104 and connections 102a, 104a.

The DRL model 200 can include the action 230. The action 230 can be a collection of possible situations or conditions in which the DRL model 200 or any portion thereof is being modeled after obtaining state information 210 from the environment. The output size of the DRL model 200 can define the action 230 size of the algorithm. In such an example, there can be one or more differing types of actions 230. For example, the action 230 size can include three different actions 230. In example only, the actions 230 can include placing, uninstalling, and idle waiting. In such example, because there are six different VNF functions, there are six different possibilities for each placing and uninstalling actions. It can be noted that these actions can define which type of VNF algorithm will work. The VNFs can be chosen according to the model action 230 which can show the type and priority metric of the VNF functions. For example, in the same timestamp, the DRL model 200 can do multiple actions 230 to satisfy the demand. Each of the multiple actions 230 can carry the previous actions' 230 changes in the environment.

In some aspects, the DRL model 200 can include a reward. The reward can be calculated after every action during one or more action phases. As used herein, the reward can be a scalar feedback which can show the agent's performance in each action 230 and it's potential results. Further, the DRL model 200 can include a penalty which can be a consequence of “bad behavior” and can be used alongside the expression reward. In an example aspect, weak definitions or incorrect values of the reward functions can lead to the DRL model 200 entering a non-convergent or local minimum state. The DRL model 200 can be configured to receive a positive high reward once it satisfies the SFC request within its E2E delay limits. The DRL model 200 can be adapted to receive a penalty if it can not satisfy the SFC request in its E2E delay, which can result in the requests being dropped. The penalty value can be configured to lower than the reward value as a result of the SFC remaining correct. Moreover, the DRL model 200 can be configured to receive another penalty for choosing invalid actions, for example and without limitation attempting to install VNF functions when the resources are unavailable because of the model's DL feature. The DRL model 200 can be configured to keep the state information 210 unchanged in the event that an invalid action occurs. In such situations, the DRL model 200 can be kept at substantially the same state until the next step.

In various embodiments, the DRL model 200 can include the DRL model processes 220 which can include a one or more input layers 221, a concatenation phase 223, and a deep neural network (DNN) layer 222. In some embodiments, deep neural networks can be included in any portion of the DRL model 200. For example, the model processing 220 aspect can include at least one DNN layer 222. For each state information 210, the model processing 220 can include one of the input layers 221. In an illustrative aspect, the first state 211 can include a first input layer 221a within the model processing 220, the second state 212 can include a second input layer 221b within the model processing 220, and the third state 213 can include a third input layer 221c within the model processing 220. Each of the first input layer 221a, the second input layer 221b, and the third input layer 221c can be linked and/or combined in the concatenation phase 223. The result can be the DNN layer 222. Each of the input layers 221 can define appropriate sizes for their dimensions.

In various aspects, the three state information 210 inputs can define dimensions and can be forwarded to a normalization step before being sent to the model processing 220. The input layers 221 can be of the same number of output neurons to provide the same number of features for the outputs or actions 230. The input layers 221 can be concatenated during the concatenation phase 223 as a result of having the same number of features and can become one instance. The one instance can be forwarded to an attention layer which can emphasize the important features thereof and can then sent through several fully connected DNN hidden layers until reaching the output layer. The output of the DRL model 200 can be extracted, and the action type along with the VNF type can be collected. In some aspects, the DRL model 200 can continue to provide priority metrics for each VNF given the type and considering the actions prior to performance of the action.

### SFC Provisioning Algorithm

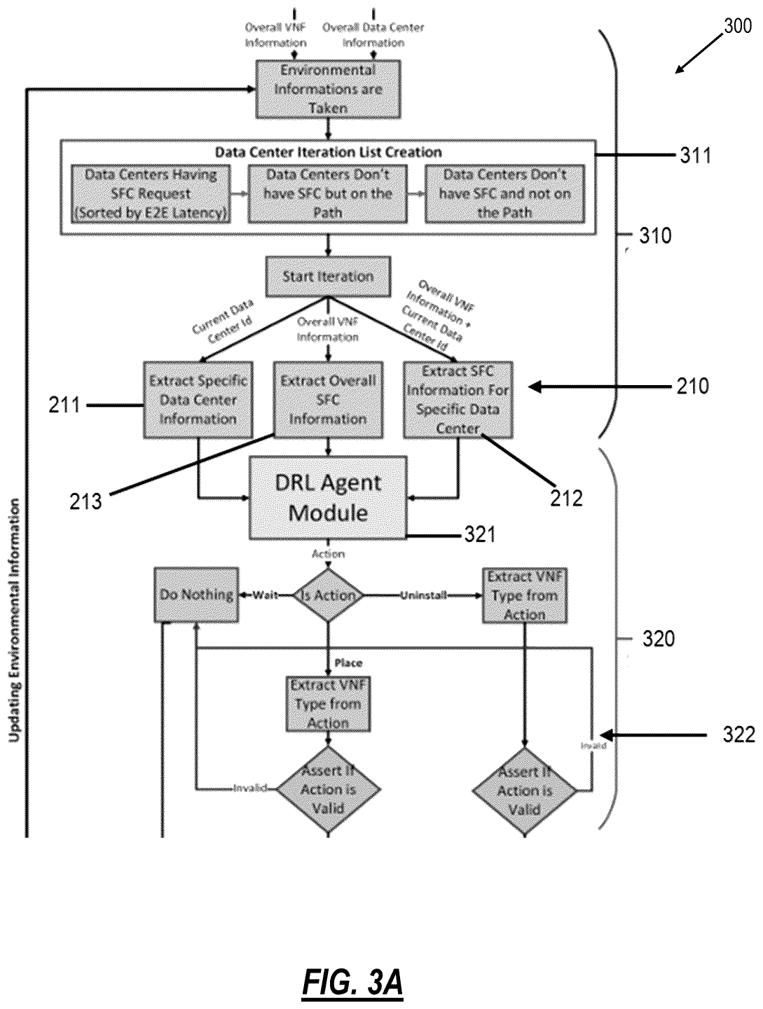

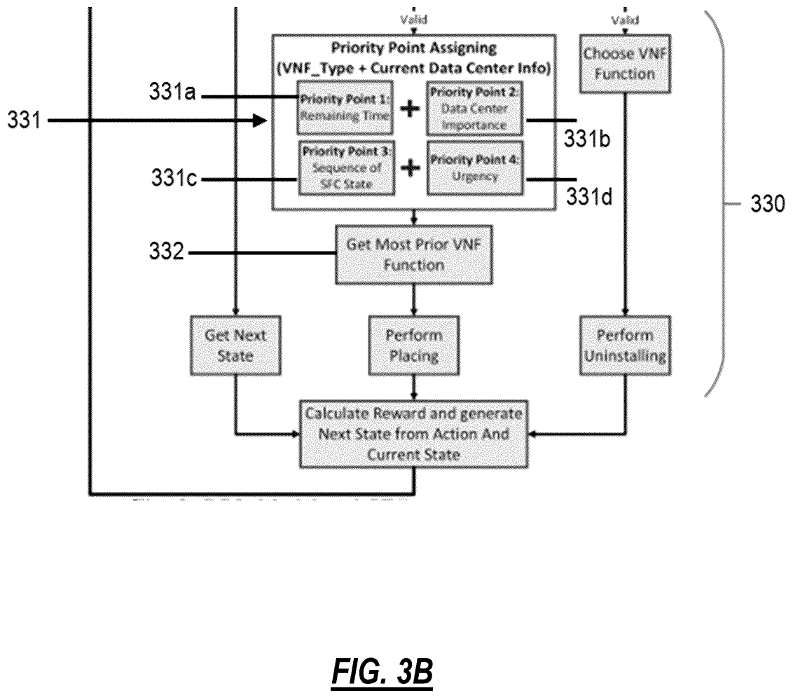

Turning now to FIGS. 3A and 3B, a diagram of a SFC provisioning algorithm 300 workflow in accordance with an alternative aspect of the present disclosure is shown and described. In some aspects, the instant application provides the SFC provisioning algorithm 300 which can be adapted for at least SFC provisioning. In some aspects, the SFC provisioning algorithm 300 can be configured to create and/or manage a sequence of connected network services or functions. For example only, and without limitation, the SFC provisioning algorithm 300 can be adapted to create and/or manage any of firewalls, load balancers, intrusion detection, data center management, or the like. In some aspects, the SFC provisioning algorithm 300 can be partitioned. In some embodiments, the SFC provisioning algorithm 300 can be partitioned into three parts, for example a first phase 310, a second phase 320, and a third phase 330. The first phase 310 can be configured for environmental state information collection and/or creation of DCs iteration order. The second phase 320 can be configured for Al model processing. The third phase 330 can be configured for priority metric assignment. In some aspects, the SFC provisioning algorithm 300 can include different state information 210, for example the first state 211, the second state 212, and the third state 213 information. In some aspects, one or more of the state information 210 can relate to SFC information and one or more of the state information 210 can relate to DC attributes. In example only, the first state 211 can relate to DC attributes and the second and third state 212, 213 can relate to SFC attributes.

In some aspects, the SFC provisioning algorithm 300 can include a DC iteration order list 311. The DC iteration order list 311 can be created before the collection of state information 210. In some embodiments, the DC iteration order list 311 can be configured to consider the importance of each DC 104 (shown in FIG. 1). In various embodiments, the DC iteration order list 311 can consider the available resources and/or incoming SFC requests' E2E delay. The SFC provisioning algorithm 300, and more specifically the DC iteration order list 311 can be configured to forward certain DCs 104 to the head of the list of the DC order iteration list 311, and then can forward DCs 104 which may not have SFC requests but are on the path between the source and the destination of the request. In some aspects, the DC order iteration list 311 can be configured to partition the SFC which have not received SFC requests to the bottom of the list of the DC order iteration list 311. In various embodiments, the DC order iteration list 311 can be configured to order at the head of the list DCs 104 receiving SFC requests which can be sorted into each other, and can consider SFC request's E2E latency. The DC order iteration list can be configured to partition DCs 104 having minimum E2E latency at the top of the list of the DC order iteration list 311. In some aspects, the SFC provisioning algorithm 300, and more specifically the DC order iteration list 311 does not have to iterate the totality of the DCs 104 on the iteration order list within it multiple action phases. In contrasting aspects, the SFC provisioning algorithm 300 action count in for example the third phase 330 can be limited in the same timestamp depending on the inference time of the SFC provisioning algorithm 300. Moreover, the SFC provisioning algorithm 300 can visit the same DC 104 during any portion of the third phase 330 wherein the DC iteration order can be updated after every action.

In some aspects, once the DC order iteration list 311 has been defined, the states can be defined by looking up the current DC attribute and/or overall SFC information. In certain aspects, SFC information can not be directly taken from the environment. The term “environment” can include an overall list of VNFs, wherein each VNF can include two IDs: Id indicates the VNF type and ID of its SFC's primary key. Each SFC can have a distinct primary Id, which can be shared among all VNFs in it's chain. The SFC provisioning algorithm 300 can be configured to, for example through the search of the aforementioned IDs, gather information regarding any of how many SFCs requests exists, the nature of the requests, and how many VNF functions remain for allocation in the SFC chain. In some aspects, the VNF functions remain for allocation in the SFC chain. The SFC provisioning algorithm 300 can be adapted to create remaining state data which can include overall SFC information in the network and SFC for the current DCs 104 alongside the DC attributes.

In some aspects, the SFC provisioning algorithm 300 can include the second phase 320. The second phase 320 can be configured to retrieve information sent thereto. For example, information gathered during the first phase 310 of the SFC provisioning algorithm 300 can be sent to the second phase 320. The second phase 320 can include the DRL model 321. The DRL model 321 can be an Al or DL model. The DRL model can be adapted to receive input layers from the first phase 310, for example three different input layers. The DRL model 321 can be configured for pure receiving of information without any loss. The DRL model 321 can include an attention layer which can be configured to help the DRL model 321 to emphasize a critical feature of a dataset. The SFC provisioning algorithm 300 can be configured to generate an output as a result of the state and model processing. In some aspects, the SFC provisioning algorithm 300 can define an action size. For illustrative example only and without limitation, the action size of the SFC provisioning algorithm 300 can be defined as follows:

$$\vert V \vert * 2 + 1 = AS$$

Where |V| represents the number of VNF types, which can be 6, 2 is the number of actions which can be performed on the VNF function, and placing and uninstalling and 1 indicates the idle waiting.

After the DRL model 321 generates an output, it can be configured to perform an assertion state 322. The assertion state 322 can be configured to decide whether the action is valid or not. One example state which the SFC provisioning algorithm 300 can determine is Idle Waiting. For such state, the assertion state 322 isn't performed since this action doesn't depend on any environmental parameter. An alternative example of a state which the SFC provisioning algorithm 300 can determine is Uninstalling, wherein the assertion state 322 can check if there are any idle VNF function with a given type in that current DC 104, and if it doesn't exist, the assertion state 322 will fail. In yet another example, the assertion state 322 can perform a two-step action such as a Placing action wherein the algorithm can first check if there are any VNF functions in a given type in the network waiting for allocation, and in the second step, the model can check if there are any available resources for that type of VNF function or idle VNF. The SFC provisioning algorithm 300 or any portion thereof can be configured to, in a first step check if there are any VNF function in a given type in the network waiting for allocation, and in a second step check if there are any available resources for that type of CNF function or idle VNF function's existence. To do this, the SFC provisioning algorithm 300 can check for satisfaction at least one of the assertion phases. If, for example, the assertion fails, the SFC provisioning algorithm 300 can perform an idle waiting automatically, and the model can receive a penalty for generating an invalid action.

In some aspects, the SFC provisioning algorithm 300 can include the third phase 330. The third phase 330 can be entered if the action from for example the assertion state 322 is valid. The third phase 330 can include the priority point state 331. The priority point state 331 can be configured to assign a priority metric, such as priority points and perform actions. For example the third phase 330 can perform an uninstalling action wherein the priority point state 331 may not assign priority metric and/or priority metrics are not collected. However, during such a state the DC 104 can maintain the information of idle functions' staying idle time. The SFC provisioning algorithm 300 can choose the idle function which has the maximum idle time and can perform uninstallation on the action. In a further example, the third phase 330 can include the Placing action, wherein the model first assigns the priority metric to the VNF functions of the selected type. The assigned priority metric can be calculated for example with a summation of priority functions. In illustrative example only, and without limitation, the SFC provisioning algorithm 300 and more specifically the third phase 330 of the SFC provisioning algorithm 300 can calculate priority point P via a summation of a first priority point 331a, a second priority point 331b, a third priority point 331c, and a fourth priority point 331d functions as illustrated below:

$$P = P 1 + P 2 + P 3 + P 4$$

Where the first priority function P1 331a can define the remaining time of VNF functions before it drops and can be calculated by:

$$P 1 = {V}_{t} - {V}_{E 2 E}$$

Where Vt is the current time after SFC demand's such as this VNF, generation wherein it can increase in every step, and Ve2e is the E2E latency for SFC which can be static. In such an example, when Vt==Ve2e, the SFC function can be dropped. The second priority point P2 331b can emphasize the importance of VNF based on its SFC's latest processed function DC. The third priority point P3 331c can be related to VNF's SFC state, where for example if any function of the VNF's SFC is deployed in the current DC, it can be configured to give a positive reward. Otherwise, it can be configured not to yield any value. Priority point P4331d can be the urgency of the VNF functions wherein even if the other VNFs in the SFC chain have been allocated to other DCs1 104, the VNF priority can be greatly raised for it's allocation if there is less time left to fulfill its SFC request than the threshold. It can be calculated by:

$$P 4 = C / ( {D}^{S} - T * {E}^{S} + ∈ )$$

Where ϵ can be a very small number to avoid division by zero.

In some aspects, the third phase 330 of the SFC provisioning algorithm 300 can be configured to assign all VNFs of the output VNF type. The third phase 330 can be structured to then select a maximum priority VNF and can be configured to perform a prior VNF retrieval step 332. In some aspects, if the idle function with VNF's type does not exist in the current DC, the model can automatically install VNF and can start function allocations. In other aspects, if idle VNFs exist, the algorithm can choose the idle function with minimum idle time, which can indicate that it was active in the most recent times. Moreover, in some aspects, the algorithm can be configured to indicate that all idle VNF functions are automatically uninstalled if their idle time exceeds the threshold.

### Exemplary Results

The following section demonstrates sample results of a system in accordance with one or more aspects of the present disclosure. It should be readily understood that such results are provided only to demonstrate an illustrative example of one or more aspects of the present disclosure and should not be construed as limiting.

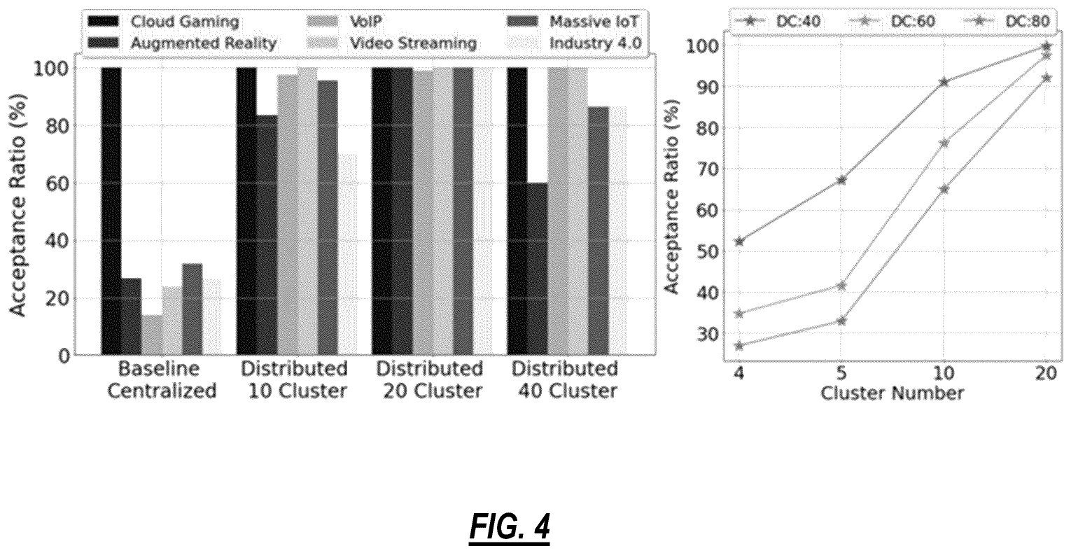

Turning now to FIG. 4 a graph of the SFC acceptance ratio in type-wise comparison to baseline centralized approach and distributed design under 40 DC and acceptance ratio under different clusters and DC numbers for distributed designs is shown and described. In FIG. 4, the left part shows the SFC acceptance ratio in type wise comparison to baseline centralized approach and distributed design with different cluster numbers under 40 DCs, while the Right Part is the SFC acceptance ratio under different Clusters and DCs Numbers for Distributed Design. Comparison is made by percentage, but each SFC type has a different amount of bundle size, which is referenced in I. SFC requests are created two times during the simulations, and SFC counts for each generation are more than the standard bundle size to make this testing more challenging. Due to the large-scale environment, with 40 DC, and a massive amount of SFC demands, single baseline centralized agents couldn't satisfy enough SFC requests. In total, it can handle only 35.03% if we consider the real bundle size instead of percentages. On the other hand, the distributed design satisfies 91.04% and 99.79% while it has 10 and 20 clusters, local agents, in the environment.

However, If the cluster number is increased to 40, which means each local agent has only 1 DC, performance is reduced to 87.99% since high communication requirements of the general agent cause delay in the process, and there are resource constraints for local agents. In the right subfigure, the distributed design's performance is tested under different network configurations, which include 40, 60, and 80 DCs and different cluster numbers, which are 4, 5, 10, and 20. It must be noted that once the network size increases, more requests are generated from the clients. A 60 DC network generates 1.5 times more SFC requests, while this number is 2 in a system having 80 DCs. While the network has 4 and 5 clusters, systems with 60 and 80 acceptance are really low, which is lower than 40%. Acceptance ratio rates are dramatically increased once the cluster number increases to 10. Although we see an increase in the acceptance rate once the cluster size is 20, the rate of increase changes is not as high as 10. In the end, the network with DC 40 gets higher acceptance than 60 and 80, but their acceptance rate is higher than 90%.

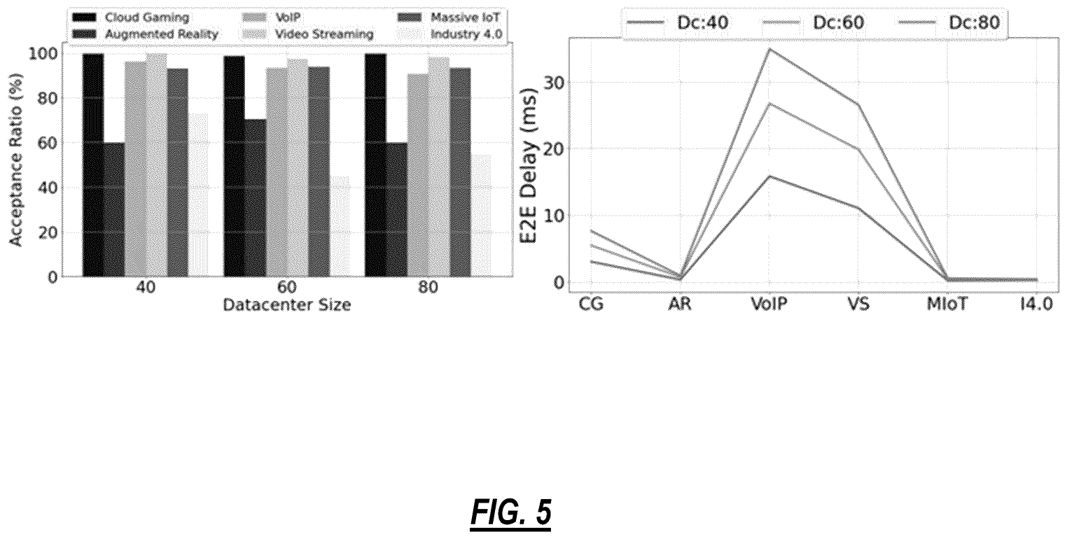

Turning now to FIG. 5 and continuing in example only, the SFC acceptance according to type and E2E are shown and described. Fixing cluster size means all agents will have a 5 DC, and it will increase the agent number on a larger scale. The left part shows the SFC type acceptance ratio, and it is clear that augmented reality can achieve the highest acceptance ratio due to its inference time value, which is 80 ms below that video streaming and VolP 100 ms, and higher than the rests which are around [5-10] ms. For this reason, after satisfying low E2E delayed requests, the model focuses on this type before working on the others. Also, augmented reality and Industry 4.0 have the highest drop ratio because of their low E2E delay constraint. Having minimum delay time makes Massive IoT prior to being processed by the algorithm. That's why its acceptance ratio is higher than augmented reality and industry 4.0. For the right side of the figure, the E2E delay increases once the number of DC increases in the network due to having more requests and longer transmission time. It must be noted that this delay value is for only accepted SFC requests, and dropped SFCs are not used in this graph. VolP and video streaming have more E2E delay due to having higher E2E delay attributes that cause them to be processed last.

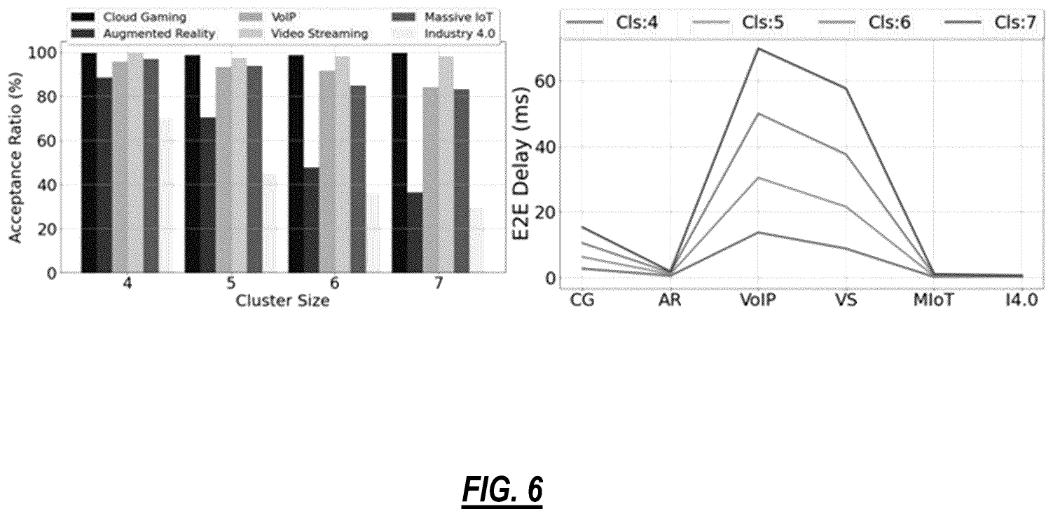

Turning now to FIG. 6, and in further continuation in example only, the impacts of cluster size on the algorithm are shown and described. he comparison is made by variable cluster size of agents. A larger cluster size gives agents more data centers and resources in their domain but reduces the agent number in the environment and makes it closer to a centralized approach. Moreover, if the agent includes a higher data center, the requirement of communication with the general agents is reduced because the probability of having a packet destination address in its domain is increased. However, it leads the model to work on more high-demand counts, making the system more challenging. Therefore, the SFC acceptance count decreases once the cluster size of the agent increases, and drops mostly occur with low E2E delay SFC requests, which are industry 4.0 and augmented reality. On the other hand, E2E delays are increased once we increase the cluster size.

### Disclosed Process

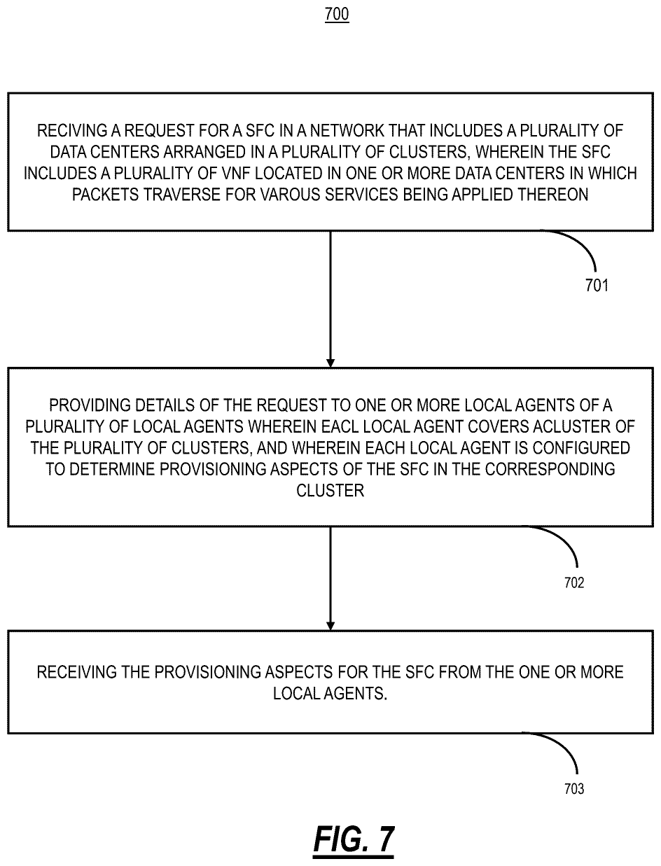

Turning now to FIG. 7, a flow diagram of a process for SFC provisioning 700 based on DRL utilizing local agents in one or more clusters in accordance with yet another aspect of the present disclosure is shown and described. In some aspects, the present disclosure contains a method for computing. The method can be the process for SFC provisioning 700. In some aspects, the process for SFC provisioning 700 can include utilizing SFC. In other aspects, the process for SFC provisioning 700 can include the use of VNFs. The process for SFC provisioning 700 can be configured for the processing of packets of data in a network. In various aspects, the process for SFC provisioning 700 can include a ML/AI interface. In some methods, the process for SFC provisioning 700 can include a first method step 701. The first method step 701 can include receiving a request for a Service Function Chain (SFC) in a network that includes a plurality of data centers arranged in a plurality of clusters, wherein the SFC includes a plurality of Virtual Network Functions (VNFs) located in one or more data centers in which packets traverse for various services being applied thereon. In other aspects, the process for SFC provisioning 700 can include a second step 702. In typical embodiments, the second step 702 can include providing details of the request to one or more local agents of a plurality of local agents, wherein each local agent covers a cluster of the plurality of clusters, and wherein each local agent is configured to determine provisioning aspects of the SFC in the corresponding cluster. In other aspects, the process for SFC provisioning 700 can include a third step 703. The third step can include receiving the provisioning aspects for the SFC from the one or more local agents 103.

The process for SFC provisioning 700 can include wherein the SFC spans at least two DCs 104 of the plurality of DCs 104, and wherein there are at least two local agents 103, each providing the provisioning aspects for the SFC in their corresponding cluster 102. The process for SFC provisioning 700 can include wherein the SFC spans a single cluster 102, and the details thereof are provided to a single local agent 103 associated with the single cluster 102. The process for SFC provisioning 700 can include wherein the SFC has a requirement related to one or more of bandwidth and latency with the one or more local agents 103 configured to determine the provision aspects of the SFC in their local cluster 102 based on the requirements and based on state information of the local cluster 102. The process for SFC provisioning 700 can include wherein the provision aspects include one or more of assignment of existing VNFs in a given cluster 102 and instantiation of new VNFs in the given cluster 102. The process for SFC provisioning 700 can include wherein, prior to the request being received, the instruction that, when executed, further cause the one or more processors to determine a number of clusters 102 of the plurality of clusters 102 and assign each of the plurality of DCs 104 into the one of the plurality of clusters 102. The process for SFC provisioning 700 can include wherein responsive to any of the one or more local agents 103 being unavailable to provide the provisioning aspects, the instructions that, when executed, cause the one or more processors to ask another local agent 103 of the one or more local agents to provide the provisioning aspects, wherein the another local agent is located in another cluster along a route of the SFC. In another aspect, the process for SFC provisioning 700 can include wherein each local agent includes a deep reinforcement learning model having a same architecture as one another and a same training.

### Processing System

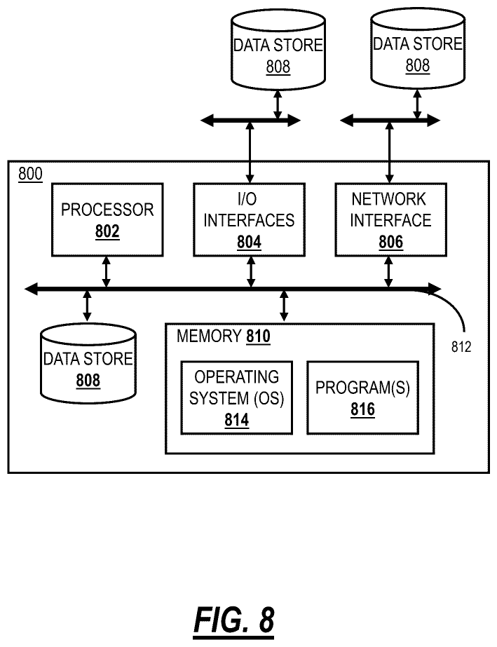

Turning now to FIG. 8, depicted is a block diagram of a processing system 800, which may be a digital computer. The system 800 generally includes one or more processors 802, input/output (I/O) interfaces 804, a network interface 806, a data store 808, and memory 810. It's important to note that FIG. 8 provides an oversimplified view of the processing system 800, and a practical embodiment may include additional components and suitably configured processing logic to support conventional operating features not detailed here. The components (802, 804, 806, 808, and 810) communicate via a local interface 812, which may consist of one or more buses or other wired or wireless connections known in the art. The local interface 812 may also include additional elements such as controllers, buffers (caches), drivers, repeaters, and receivers to facilitate communications. Furthermore, the local interface 812 may include address, control, and/or data connections to enable appropriate communications among the aforementioned components.

The processor 802 is a hardware device designed to execute software instructions. It can be a custom-made or commercially available processor, namely any device capable of executing software instructions. When the processing system 800 is operational, the processor 802 executes software stored in the memory 810, communicates data to and from the memory 810, and generally controls the operations of the processing system 800 based on the software instructions. The I/O interfaces 804 are used to receive user input from and provide system output to one or more devices or components. The network interface 806 enables the processing system 800 to communicate on a network, such as the Internet 104. It may include an Ethernet card or adapter or a Wireless Local Area Network (WLAN) card or adapter. The network interface 806 includes address, control, and/or data connections to enable appropriate communications on the network.

The data store 808 is used to store data and may include volatile memory elements (e.g., random access memory (RAM) such as DRAM, SRAM, SDRAM, etc.), nonvolatile memory elements (e.g., ROM, hard drive, tape, CD-ROM, etc.), and combinations thereof. The data store 808 can incorporate electronic, magnetic, optical, and/or other types of storage media. For instance, it may be an internal hard drive connected to the local interface 812 within the processing system 800. Alternatively, the data store 808 could be an external hard drive connected to the I/O interfaces 804 (e.g., via SCSI or USB connection) or a network-attached file server.

The memory 810 may include volatile memory elements (e.g., RAM such as DRAM, SRAM, SDRAM, etc.), nonvolatile memory elements (e.g., ROM, hard drive, tape, CD-ROM, etc.), and combinations thereof. It may incorporate electronic, magnetic, optical, and/or other types of storage media. The memory 810 may have a distributed architecture, with components situated remotely but accessible by the processor 802. The software in memory 810 includes one or more programs, each containing an ordered list of executable instructions for implementing logical functions. The memory 810 includes a suitable Operating System (O/S) 814 and one or more programs 816. The operating system 814 controls the execution of other computer programs, such as the one or more programs 816, and provides scheduling, input-output control, file and data management, memory management, communication control, and related services. The one or more programs 816 may implement the various processes, algorithms, methods, techniques, etc., described herein.

In some embodiments, one or more processing systems 800 can be configured as part of a cloud system. Cloud computing systems and methods abstract away physical servers, storage, and networking, offering these as on-demand and elastic resources. The National Institute of Standards and Technology (NIST) defines cloud computing as a model for enabling convenient, on-demand network access to a shared pool of configurable computing resources (e.g., networks, servers, storage, applications, and services) that can be rapidly provisioned and released with minimal management effort or service provider interaction. The phrase “Software as a Service” (SaaS) is often used to describe application programs offered through cloud computing. The term “the cloud” is commonly used as shorthand for a provided cloud computing service or an aggregation of all existing cloud services.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. A system comprising:
one or more processors, and memory storing instructions that, when executed, cause the one or more processors to
receive a request for a Service Function Chain (SFC) in a network that includes a plurality of data centers arranged in a plurality of clusters, wherein the SFC includes a plurality of Virtual Network Functions (VNFs) located in one or more data centers in which packets traverse for various services being applied thereon,
provide details of the request to one or more local agents of a plurality of local agents, wherein each local agent covers a cluster of the plurality of clusters, and wherein each local agent is configured to determine provisioning aspects of the SFC in a corresponding cluster, and
receive the provisioning aspects for the SFC from the one or more local agents.

2. The system of claim 1, wherein the SFC spans at least two data centers of the plurality of data centers, and wherein there are at least two local agents, each providing the provisioning aspects for the SFC in their corresponding cluster.

3. The system of claim 1, wherein the SFC spans a single cluster, and the details are provided to a single local agent associated with the single cluster.

4. The system of claim 1, wherein the SFC has a requirement related to one or more of bandwidth and latency with the one or more local agents configured to determine the provisioning aspects of the SFC in their local cluster based on the requirements and based on state information of the local cluster.

5. The system of claim 1, wherein the provisioning aspects include one or more of assignment of existing VNFs in a given cluster and instantiation of new VNFs in the given cluster.

6. The system of claim 1, wherein, prior to the request being received, the instructions that, when executed, further cause the one or more processors to determine a number of clusters of the plurality of clusters and assign each of the plurality of data centers into one of the plurality of clusters.

7. The system of claim 1, wherein, responsive to any of the one or more local agents being unable to provide the provisioning aspects, the instructions that, when executed, further cause the one or more processors to
ask another local agent of the one or more local agents to provide the provisioning aspects, wherein the another local agent is located in another cluster along a route of the SFC.

8. The system of claim 1, wherein each local agent includes a Deep Reinforcement Learning (DRL) model having a same architecture as one another and same training.

9. A method comprising steps of:
receiving a request for a Service Function Chain (SFC) in a network that includes a plurality of data centers arranged in a plurality of clusters, wherein the SFC includes a plurality of Virtual Network Functions (VNFs) located in one or more data centers in which packets traverse for various services being applied thereon;
providing details of the request to one or more local agents of a plurality of local agents, wherein each local agent covers a cluster of the plurality of clusters, and wherein each local agent is configured to determine provisioning aspects of the SFC in a corresponding cluster; and
receiving the provisioning aspects for the SFC from the one or more local agents.

10. The method of claim 9, wherein the SFC spans at least two data centers of the plurality of data centers, and wherein there are at least two local agents, each providing the provisioning aspects for the SFC in their corresponding cluster.

11. The method of claim 9, wherein the SFC has a requirement related to one or more of bandwidth and latency with the one or more local agents configured to determine the provisioning aspects of the SFC in their local cluster based on the requirements and based on state information of the local cluster.

12. The method of claim 9, wherein the provisioning aspects include one or more of assignment of existing VNFs in a given cluster and instantiation of new VNFs in the given cluster.

13. The method of claim 9, wherein, prior to the request being received, the steps further include
determining a number of clusters of the plurality of clusters and assign each of the plurality of data centers into one of the plurality of clusters.

14. The method of claim 9, wherein, responsive to any of the one or more local agents being unable to provide the provisioning aspects, the steps further include
asking another local agent of the one or more local agents to provide the provisioning aspects, wherein the another local agent is located in another cluster along a route of the SFC.

15. A non-transitory computer-readable medium comprising instructions that, when executed, cause one or more processors to implement steps of:
receiving a request for a Service Function Chain (SFC) in a network that includes a plurality of data centers arranged in a plurality of clusters, wherein the SFC includes a plurality of Virtual Network Functions (VNFs) located in one or more data centers in which packets traverse for various services being applied thereon;
providing details of the request to one or more local agents of a plurality of local agents, wherein each local agent covers a cluster of the plurality of clusters, and wherein each local agent is configured to determine provisioning aspects of the SFC in a corresponding cluster; and
receiving the provisioning aspects for the SFC from the one or more local agents.

16. The non-transitory computer-readable medium of claim 15, wherein the SFC spans at least two data centers of the plurality of data centers, and wherein there are at least two local agents, each providing the provisioning aspects for the SFC in their corresponding cluster.

17. The non-transitory computer-readable medium of claim 15, wherein the SFC spans a single cluster, and the details are provided to a single local agent associated with the single cluster.

18. The non-transitory computer-readable medium of claim 15, wherein the SFC has a requirement related to one or more of bandwidth and latency with the one or more local agents configured to determine the provisioning aspects of the SFC in their local cluster based on the requirements and based on state information of the local cluster.

19. The non-transitory computer-readable medium of claim 15, wherein the provisioning aspects include one or more of assignment of existing VNFs in a given cluster and instantiation of new VNFs in the given cluster.

20. The non-transitory computer-readable medium of claim 15, wherein, responsive to any of the one or more local agents being unable to provide the provisioning aspects, the instructions that, when executed, further cause the one or more processors to ask another local agent of the one or more local agents to provide the provisioning aspects, wherein the another local agent is located in another cluster along a route of the SFC.
